(19) United States
(12) Patent Application Publication
(10) Pub. No.: US 2024/0135281 A1
(43) Pub. Date: Apr. 25, 2024

(54) INFORMATION TECHNOLOGY AUTOMATION BASED ON JOB RETURN ON INVESTMENT

(71) Applicant: Dell Products L.P., Round Rock, TX (US)

(72) Inventors: George Christopher Lincoln, IV, Temple, TX (US); Susan E. Young, North Scituate, RI (US)

(21) Appl. No.: 18/047,938

(22) Filed: Oct. 18, 2022

(51) Int. Cl. G06Q 10/0631

(52) U.S. Cl. CPC G06Q 10/06313

(57) ABSTRACT

A system for assigning resources to workloads based on return on investment (ROI) comprises receiving a plurality of job requests and determining a cost and a revenue associated with processing the job requests using local resources and determining a cost and a revenue associated with processing the job requests using resources communicatively coupled over a network. The cost of using resources communicatively coupled over a network may fluctuate, even throughout a day such that the ROI for a job request may vary accordingly. Embodiments may continuously monitor costs and assign resources based on ROI.

### BACKGROUND

### Field of the Disclosure

This disclosure relates generally to information handling systems and, more particularly, to methods for implementing IT automation based on job return on investment (ROI).

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various information handling systems support a variety of jobs. Each of the different kinds of jobs puts different kinds of unique loads on the storage system. In addition, different industry will have different kinds of jobs. For example, a storage system for a financial company will have different jobs than a storage system for a medical imaging company or a networking system for a shipping company. Also, jobs are not static and may constantly change. It is challenging to be aware of different kind of jobs supported by customer's systems.

### SUMMARY

Embodiments may be generally directed to a methodology for calculating return on investment to influence resource scheduling and scaling decisions for one or more jobs running on a datacenter or public cloud infrastructure.

Embodiments may be generally directed to a method of processing information using a plurality of sets of information technology (IT) resources. The method may comprise receiving a plurality of job requests, determining a set of processing criteria for each job request, determining a first return on investment (ROI) associated with a first set of IT resources processing a first set of the plurality of job requests using and a second set of IT resources processing a second set of the plurality of job requests, determining a second ROI associated with processing the first set of the plurality of job requests using the second set of IT resources and the second set of the plurality of job requests using the first set of IT resources, and sending a set of instructions to the first set of IT resources and the second set of IT resources to process the first set of the plurality of job requests and the second set of the plurality of job requests based on the first ROI or the second ROI.

In some embodiments, the set of processing criteria includes one or more of: a deadline for completion, a customer ranking, a minimum profitability threshold, and a maximum cost threshold. In some embodiments, the first set of IT resources comprises internal IT resources and the second set of IT resources comprises external IT resources communicatively coupled over a network. In some embodiments, the method further comprises determining a third ROI associated with deprioritizing a third set of the plurality of job requests. In some embodiments, the set of processing criteria includes one or more of a revenue for fulfilling the job request and a cost for not fulfilling the job request. In some embodiments, the method further comprises determining a ranking rule associated with one or more users and assigning one or more of the first set of IT resources or the second set of IT resources based on the ranking rule.

Embodiments may be generally directed to a system for managing IT resources to fulfill a plurality of job requests. The system may comprise a plurality of information technology (IT) resources and a resource managing information handling system configured to receive a plurality of job requests from a plurality of user systems, determine a set of processing criteria for each job request, determine a first return on investment (ROI) associated with a first set of the plurality of IT resources processing a first set of the plurality of job requests using and a second set of the plurality of IT resources processing a second set of the plurality of job requests, determine a second ROI associated with processing the first set of the plurality of job requests using the second set of the plurality of IT resources and the second set of the plurality of job requests using the first set of the plurality of IT resources, and send a set of instructions to the first set of IT resources and the second set of IT resources to process the first set of the plurality of job requests and the second set of the plurality of job requests based on the first ROI or the second ROI.

In some embodiments, the set of processing criteria includes one or more of: a deadline for completion, a customer ranking, a minimum profitability threshold, and a maximum cost threshold. In some embodiments, the first set of IT resources comprises internal IT resources and the second set of IT resources comprises external IT resources communicatively coupled over a network. In some embodiments, the system is further configured to determine a third ROI associated with deprioritizing a third set of the plurality of job requests. In some embodiments, the set of processing criteria includes one or more of a revenue for fulfilling the job request and a cost for not fulfilling the job request. In some embodiments, the system is further configured to determine a ranking rule associated with one or more users and assign one or more of the first set of IT resources or the second set of IT resources based on the ranking rule.

### BRIEF DESCRIPTION OF THE DRAWINGS

For a more complete understanding of the invention and its features and advantages, reference is now made to the following description, taken in conjunction with the accompanying drawings, in which:

FIG. 1 is a chart depicting a plurality of job requests with basic parameters for assigning IT resources;

FIG. 2 is flow diagram illustrating a common approach to assigning IT resources based on the technical parameters of the IT resources;

FIG. 3 is a block diagram of selected elements of an embodiment of a resource managing information handling system;

FIG. 4 is a flow diagram illustrating one embodiment of a method for assigning information handling resources based on job ROI; and

FIG. 5 is a chart depicting a plurality of jobs with ROI parameters for assigning IT resources using the flow diagram depicted in FIG. 4; and

FIG. 6 is a chart depicting a plurality of jobs with ROI parameters for assigning IT resources using the flow diagram depicted in FIG. 4; and

FIG. 7 is a chart depicting a plurality of jobs with ROI parameters for assigning IT resources using the flow diagram depicted in FIG. 4.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, user system “30-1” refers to an instance of a user system, which may be referred to collectively as user systems “30” and any one of which may be referred to generically as user system “30.”

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and one or more video displays. The information handling system may also include one or more buses operable to transmit communication between the various hardware components.

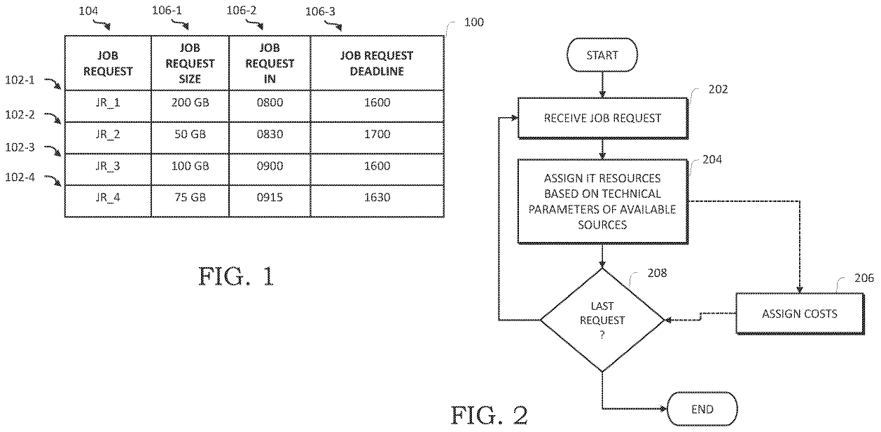

Embodiments disclosed herein are described with respect to information handling systems communicatively coupled to a plurality of user systems but may also be practiced with other resources. Particular embodiments are best understood by reference to FIGS. 1-7, wherein like numbers are used to indicate like and corresponding parts.

Referring to FIG. 1, data structure 100 may store a plurality of job requests received from a plurality of user systems, wherein each row 102 contains information for a job request and the plurality of job requests may specify different amounts of data and have different deadlines for processing the data. For example, row 102-1 contains job request information for a first job request (e.g., JR_1) including job request size 106-1 (e.g., 200 GB of data), job request received time 106-2 (e.g., 0800) and job request deadline 106-3 (e.g., 1600).

FIG. 2 depicts a flow diagram 200 of a common approach to assigning IT resources to job requests received from a plurality of user systems 30.

At step 202, an IT system may receive a job request.

At step 204, the IT system may analyze one or more technical parameters and assign an IT resource accordingly. Thus, when a first job request (e.g., JR_1) is received, IT resources are typically assigned based on what IT resources are available and the capability of the IT resources to complete the job request before the job request deadline (e.g., 1600 for JR_1); when a second job request (e.g., JR_2) is received, IT resources are typically assigned based on what IT resources are available and the capability of the IT resources to complete the job request before a deadline (e.g., 1700 for JR_2), and so forth. As an example, when JR_1 is received, the IT system may determine JR_1 comprises 200 GB of data and identify an internal IT resource (e.g., a local server) capable of processing the data and assign the internal system to process JR_1, regardless of other considerations. Notably, when a third job request (e.g., JR_3) is received, if the internal IT resource is already assigned to process a previously received job request, some approaches may assign an external IT resource (e.g., a cloud-based resource) to process data for the third job request.

In some IT systems, at step 206, the IT system may assign costs to the different IT resources.

At step 208, the IT system may determine if there are any more job requests. If so, the process repeats. Otherwise, the process may end.

### Assigning it Resources Based on Return on Investment (ROI)

Every IT job request ultimately serves a business objective. This objective may be directly revenue generating, business operational, regulatory, or any other sort of business-related activity. That objective has a certain cost and benefit to the business. Return on investment (ROI) in this context may correspond to the cost of an IT action (for example, bursting an application to the public cloud for some time-based fee), compared to the potential business revenue or offset costs of executing the same action. The success of this approach may rely on having an accurate understanding of all the costs of operating an IT resource, as well as the economic benefit of the same.

Costs and revenues may fluctuate frequently. The trends towards “as-a-Service” models of IT delivery may provide a picture of the costs to run an IT job—whether this is in a flat per hour charge of an application running as a container in a public cloud provider or the cost involved for all the infrastructure components and their overhead in a datacenter (equipment capital expense and depreciation, power, cooling, operational staff, etc.). These variables may shift frequently, as well; examples may include burst pricing in public cloud infrastructure, wholesale electricity prices, real time profitability of the results of an IT job, etc.). Other variables that influence cost and revenue that affect ROI include the cost of failure, meeting service level minimums and thresholds (e.g., a scale down action for a critical application might never go below a basic high availability threshold, regardless of utilization). Embodiments may periodically or continuously communicate with other systems (internal and external) to get accurate costs associated with various IT resources. For example, internal systems may store information associated with capital expenses and operational expenses, depreciation, power usage and cost, cooling costs, operational staff costs associated with maintaining internal IT resources. Internal systems may also store information corresponding to a cost of failure, minimum service level thresholds and minimum application utilization thresholds. External systems may provide information such as a cost per hour for a public cloud associated with a workload size or processing speed.

Orchestration actions to maximize ROI would likely include more than basic scale actions—it may even mean migrating jobs between datacenters or public cloud providers, changing the job type (for example, from a dedicated bare metal server to a batch process), or even including technical capabilities (such as GPU-intensive jobs). Processing criteria may include business revenue of the result of an IT job, the cost of all infrastructure options available (whether there is an OpEx dollar amount such as a public cloud or the sum cost of on-prem resources in CapEx, operations, etc.), cost of failure, service level agreement information, etc.

Embodiments disclosed herein may consider scale and placement actions for a job for performance and further factor costs or ROI based on infrastructure utilization or public cloud cost for ongoing optimization between jobs. Additionally, jobs may be evaluated independently and indexed against each other for business value. As a result, job placement and sizing may be based on business value. Furthermore, infrastructure utilization levels and investment in upgrades, expansions, etc. may be considered in light of the business value of each application hosted. Similarly, public cloud spending may be profit maximized based on the real value of an application.

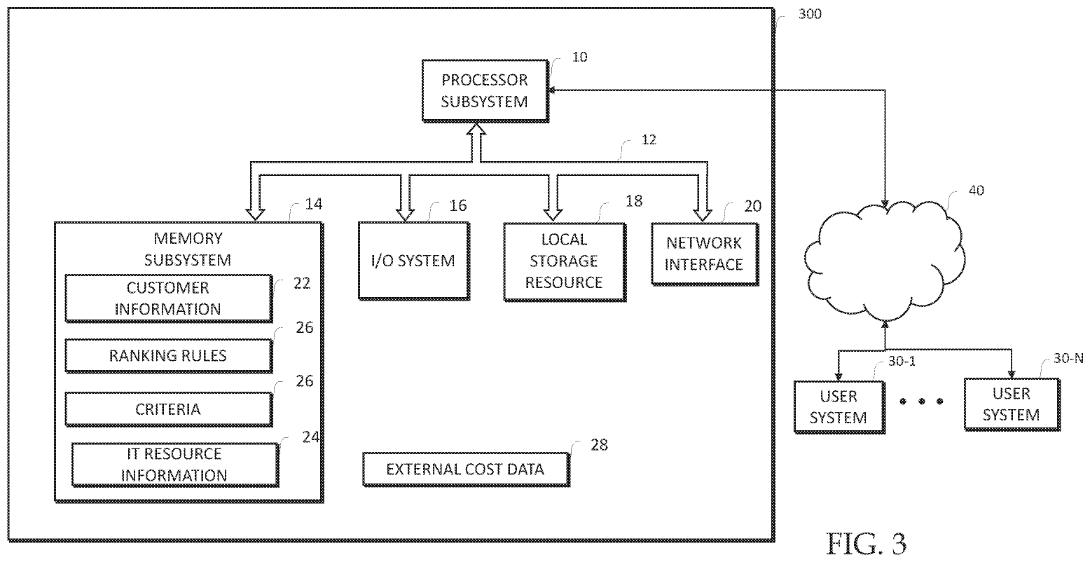

FIG. 3 illustrates a block diagram depicting selected elements of an embodiment of resource managing information handling system 300. It is noted that FIG. 3 is not drawn to scale but is a schematic illustration.

As shown in FIG. 3, components of resource managing information handling system 300 may include, but are not limited to, a processor subsystem 10, which may comprise one or more processors, and a system bus 12 that communicatively couples various system components to processor subsystem 10 including, for example, memory subsystem 14, I/O subsystem 16, local storage resource 18, and network interface 20.

Processor subsystem 10 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 10 may interpret and execute program instructions and process data stored locally (e.g., in memory subsystem 14). In the same or alternative embodiments, processor subsystem 10 may interpret and execute program instructions and process data stored remotely (e.g., in a network storage resource).

System bus 12 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 14 may comprise a system, device, or apparatus operable to retain and retrieve program instructions and data for a period of time (e.g., computer-readable media). Memory subsystem 14 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 300, is powered down.

In resource managing information handling system 300, I/O subsystem 16 may comprise a system, device, or apparatus generally operable to receive and transmit data to or from or within resource managing information handling system 300. I/O subsystem 16 may represent, for example, a variety of communication interfaces, graphics interfaces, video interfaces, user input interfaces, and peripheral interfaces. In various embodiments, I/O subsystem 16 may be used to support various peripheral devices, such as a touch panel, a display adapter, a keyboard, a touch pad, or a camera, among other examples. In some implementations, I/O subsystem 16 may support so-called ‘plug and play’ connectivity to external devices, in which the external devices may be added or removed while resource managing information handling system 300 is operating.

Local storage resource 18 may comprise computer-readable media (e.g., hard disk drive, floppy disk drive, CD-ROM, and other type of rotating storage media, flash memory, EEPROM, or another type of solid-state storage media) and may be generally operable to store instructions and data.

Network interface 20 may be a suitable system, apparatus, or device operable to serve as an interface between resource managing information handling system 300 and a network (not shown). Network interface 20 may enable resource managing information handling system 300 to communicate over a network using a suitable transmission protocol or standard. In some embodiments, network interface 20 may be communicatively coupled via a network to a network storage resource (not shown). A network coupled to network interface 20 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). A network coupled to network interface 20 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. A network coupled to network interface 20 or various components associated therewith may be implemented using hardware, software, or any combination thereof.

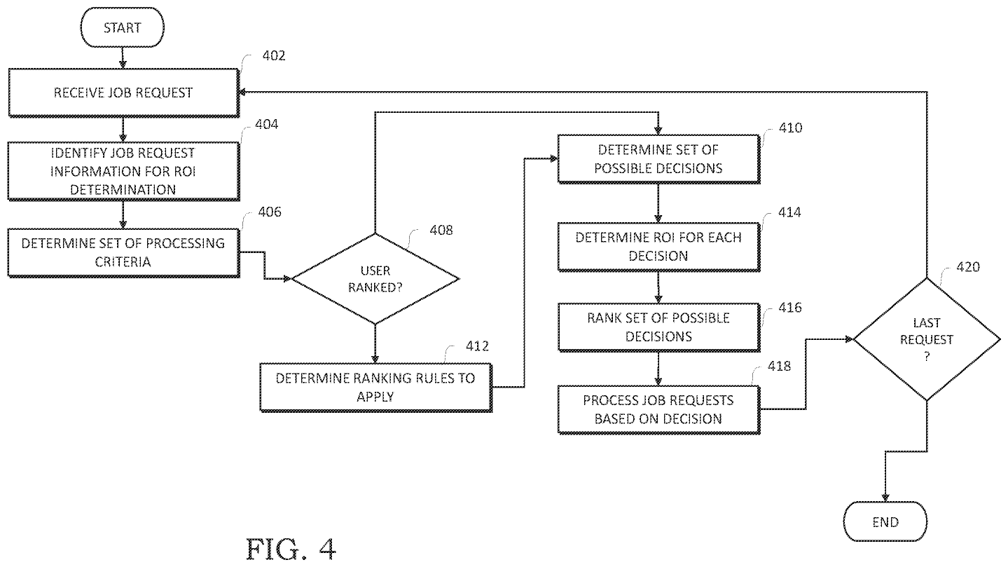

Turning to FIG. 4, flow diagram 400 depicts a method for assigning IT resources to job requests based on ROI.

At step 402, resource managing information handling system 300 receives a job request.

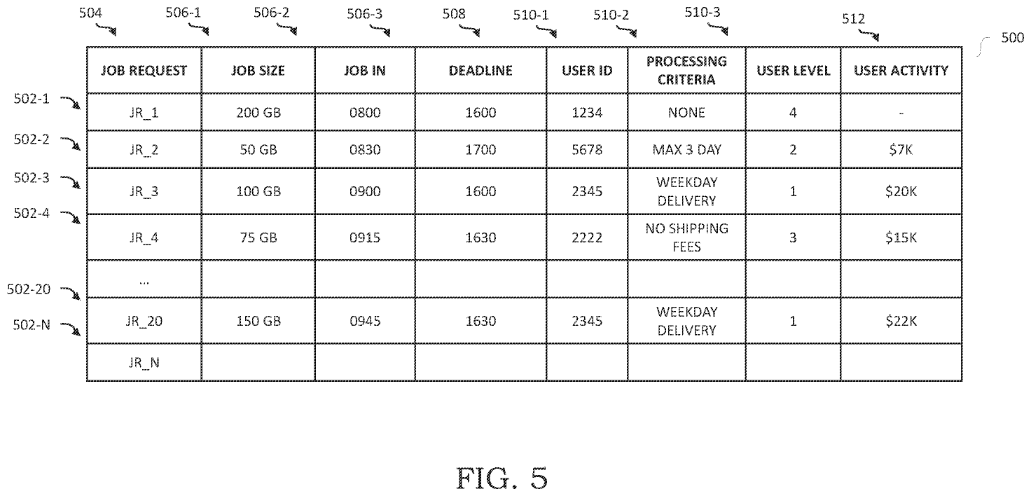

At step 404, resource managing information handling system 300 analyzes the job request to identify job request information. Referring to FIG. 5, data structure 500 may store job request information, which may include column 504 storing job request identifier, columns 506 storing values for one or more of a job request size, a job request received time and a job request deadline, and columns 510 storing a user identifier associated with the job request. Resource managing information handling system 300 may determine, based on the user identifier, additional user information such as a user level and a user activity, and one or more ranking rules.

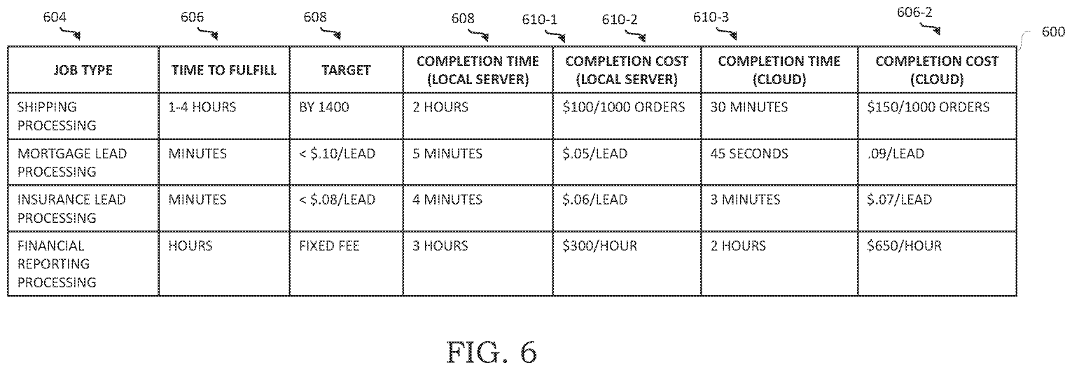

At step 406, resource managing information handling system 300 may determine a set of processing criteria. FIG. 6 depicts data structure 600 storing processing criteria. Processing criteria may include business revenue of the result of an IT job. For example, for job requests received from users associated with shipping, processing shipping data should be completed in 1-4 hours and before 1400 to enable the user to use the processed information to fulfill orders and ship the orders the same day. For job requests received from users associated with mortgage lead processing, processing mortgage leads should be completed in minutes and at less than $0.10 per lead to enable the user to contact a person inquiring about a mortgage as soon as possible. Processing criteria may differ for different users.

At step 408, resource managing information handling system 300 may determine if one or more ranking rules should apply.

If no ranking rules need to be applied, then at step 410, resource managing information handling system 300 may determine a plurality of possible decisions.

If the job request is associated with a ranked user, then at step 412, resource managing information handling system 300 may determine one or more ranking rules to apply. For example, a ranking rule may indicate that a selected user ID (e.g., user 2345) has a preferred status (e.g., user level 1) such that a job request should be processed to allow weekday delivery. As another example, a ranking rule may indicate that a job request should be processed before a deadline on any day (e.g., maximum 3-day delivery for user ID 5678).

At step 414, resource managing information handling system 300 may determine an ROI associated with each decision. Ranking rules may be used to further develop an accurate return on investment for certain job requests.

At step 416, resource managing information handling system 300 may rank the plurality of possible decisions.

At step 418, resource managing information handling system 300 may select a decision of the set of possible decisions and process information according to the selected decision.

At step 420, resource managing information handling system 300 may determine if there are additional job requests. If so, then resource managing information handling system 300 may perform steps 402-418. If not, then the method may end.

FIG. 5 depicts a chart 500 illustrating data structure containing rows 502-1 to 502-N of job request information received from a plurality of user systems 30. Column 504 may contain a value for job number, columns 506 may contain job information (e.g., a job size, when the job request was received and a deadline for fulfilling the job request), column 508 may contain an NPS score and columns 510 may contain customer information (e.g., a user identifier (ID), a user level, user activity) and column 512 may contain ranking rules.

Referring to rows 502-3 and 502-20, job requests from a user (e.g., user ID 2345) might not have been received first, but they may still get a higher ranking due to an agreement, the amount of user activity or some other criteria.

FIG. 6 depicts a chart 600 illustrating a data structure containing rows 602-1 to 602-N of criteria for processing job requests. Column 604 may contain information about a job type, columns 606 may contain a time needed to fulfill job requests having the job type specified in column 504, column 608 may contain a target deadline (e.g., for shipping processing, an earlier deadline may be needed to account for the time needed to load a truck and/or meet a flight deadline), columns 610 may contain information (e.g., completion time and completion cost) associated with a first IT resource (e.g., a local server) and columns 512 may contain information (e.g., completion time and completion cost) associated with a second IT resource (e.g., a cloud-based system).

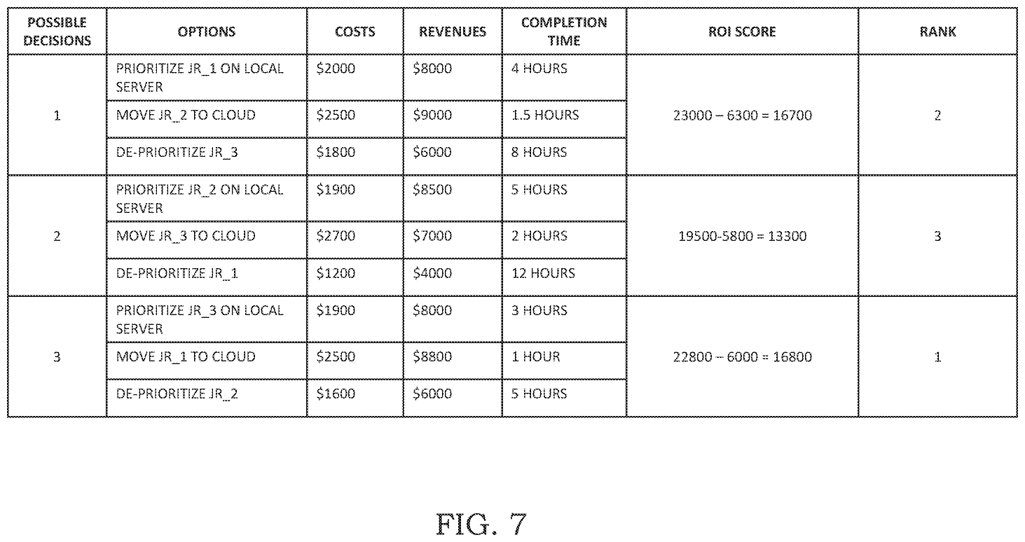

FIG. 7 depicts chart 700 illustrating a data structure containing rows 702-1 to 702-N of possible decisions. Column 704 may contain decision information, column 706 may contain cost information associated with the decision, column 706-2 may contain revenue information associated with the decision, column 710 may contain completion time for the decision, column 712 may contain score information for the decision and column 714 may contain rank information for the decision.

Referring to FIG. 7, a first possible decision may involve prioritizing a first job request (e.g., JR_1) on a local server, moving a second job request (e.g., JR_2) to cloud IT resources and de-prioritizing a third job request (e.g., JR_3). A second possible decision may involve prioritizing the second job request (e.g., JR_2) on the local server, moving the third job request (e.g., JR_3) to cloud IT resources and de-prioritizing the first job request (e.g., JR_1). A third possible decision may involve prioritizing the third job request (e.g., JR_3) on the local server, moving the first job request (e.g., JR_1) to cloud IT resources and de-prioritizing the second job request (e.g., JR_2). FIG. 7 depicts data structure 700 having only three decisions, but embodiments may receive hundreds of job requests from various users in different industries and with different business goals and may generate data structure having hundreds or even thousands of possible decisions.

Resource managing information handling system 300 may generate data structure 700 and update data structure 700. For example, a cost associated with an internal IT resource may be generally constant, but a cost associated with a cloud-based IT resource may vary depending on the day of the month, the time of day, etc. Accordingly, a possible decision determined early in the day and early in the month may have a higher ROI than the same decision determined later in the same day and/or later in the same month. Also, a possible decision may have a higher ROI for a preferred user than the same decision for a new user, for a different job size, for a different deadline.

Embodiments disclosed herein may identify one or more possible sources of business value and calculate an ROI based on the business value to determine actions to meet a target ROI for jobs running in a constrained environment.

Embodiments may calculate ROI of job output, compare this ROI to other scale actions, and execute the scale actions.

Based on an understanding of the value of a job, an ROI analysis may be calculated on the result of processing a job faster through increased infrastructure scale or the money saved by processing the job slower through reduced infrastructure scale.

### EXAMPLES

Resource managing information handling system 300 may receive job requests with large and multiple datasets corresponding to processing leads for a financial service product, wherein processing the data may involve communicating with financial institutions (e.g., banks, credit bureaus) and scoring the value of a potential lead for a sale of a financial service product, such as insurance or mortgage, where time to produce an accurate decision on the lead is critical for being the first-mover. Producing accurate lead decisions in a shorter period may be important to a user and may have increased revenue potential for a higher ROI. Resource managing information handling system 300 may determine that sending a job request to a cloud-based IT resource may be more expensive but may bring in more revenue such that there is a higher ROI as compared to processing leads using local IT resources.

Resource managing information handling system 300 may receive job requests with large and multiple datasets corresponding to processing accurate cubing services by a large shipping facility, where fulfilling all cube operations for shipping container selection by a shipping cutoff has business value (e.g., early and/or on-time shipments may result in higher customer satisfaction and late shipments may have a financial loss and/or penalty). If the datasets are received early in the day or on a weekend, resource managing information handling system 300 may assign a local server to process the information. Alternatively, if the datasets are received later in the day or on a Wednesday or Thursday, resource managing information handling system 300 may assign a an IT resource that can process the data to get the most packages shipped (to reduce inventory).

Resource managing information handling system 300 may receive job requests with large and multiple datasets corresponding to financial reporting. Financial reporting metrics are of extreme importance and time critical during regulatory end-of-period windows, but less so during out-of-band cycles. There may be an OpEx optimization to having a dedicated, high performance environment during critical periods, and utilizing a slower, shared batch processing during non-critical periods. Thus, resource managing information handling system 300 may receive job requests with large and multiple datasets corresponding to financial reporting, determine an ROI may be based on avoiding late penalties, determine deadlines for financial reporting based on information in the datasets and assign a higher rank to a user requesting financial reporting.

The above disclosed subject matter is to be considered illustrative, and not restrictive, and the appended claims are intended to cover all such modifications, enhancements, and other embodiments which fall within the true spirit and scope of the disclosure. Thus, to the maximum extent allowed by law, the scope of the disclosure is to be determined by the broadest permissible interpretation of the following claims and their equivalents, and shall not be restricted or limited by the foregoing detailed description.

1. A method of processing information using a plurality of sets of information technology (IT) resources, the method comprising:
receiving a plurality of job requests;
determining a set of processing criteria for each job request;
determining a first return on investment (ROI) associated with a first set of IT resources processing a first set of the plurality of job requests using and a second set of IT resources processing a second set of the plurality of job requests;
determining a second ROI associated with processing the first set of the plurality of job requests using the second set of IT resources and the second set of the plurality of job requests using the first set of IT resources; and
sending a set of instructions to the first set of IT resources and the second set of IT resources to process the first set of the plurality of job requests and the second set of the plurality of job requests based on the first ROI or the second ROI.

2. The method of claim 1, wherein the set of processing criteria includes one or more of: a deadline for completion, a customer ranking, a minimum profitability threshold, and a maximum cost threshold.

3. The method of claim 1, wherein the first set of IT resources comprises internal IT resources and the second set of IT resources comprises external IT resources communicatively coupled over a network.

4. The method of claim 1, further comprising determining a third ROI associated with deprioritizing a third set of the plurality of job requests.

5. The method of claim 1, wherein the set of processing criteria includes one or more of a revenue for fulfilling the job request and a cost for not fulfilling the job request.

6. The method of claim 1, further comprising determining a ranking rule associated with one or more users and assigning one or more of the first set of IT resources or the second set of IT resources based on the ranking rule.

7. A system, comprising:
a plurality of information technology (IT) resources; and
a resource managing information handling system configured to:
receive a plurality of job requests from a plurality of user systems;
determine a set of processing criteria for each job request;
determine a first return on investment (ROI) associated with a first set of the plurality of IT resources processing a first set of the plurality of job requests using and a second set of the plurality of IT resources processing a second set of the plurality of job requests;
determine a second ROI associated with processing the first set of the plurality of job requests using the second set of the plurality of IT resources and the second set of the plurality of job requests using the first set of the plurality of IT resources; and
send a set of instructions to the first set of IT resources and the second set of IT resources to process the first set of the plurality of job requests and the second set of the plurality of job requests based on the first ROI or the second ROI.

8. The system of claim 7, wherein the set of processing criteria includes one or more of: a deadline for completion, a customer ranking, a minimum profitability threshold, and a maximum cost threshold.

9. The system of claim 7, wherein the first set of IT resources comprises internal IT resources and the second set of IT resources comprises external IT resources communicatively coupled over a network.

10. The system of claim 7, further configured to determine a third ROI associated with deprioritizing a third set of the plurality of job requests.

11. The system of claim 7, wherein the set of processing criteria includes one or more of a revenue for fulfilling the job request and a cost for not fulfilling the job request.

12. The system of claim 7, further configured to determine a ranking rule associated with one or more users and assign one or more of the first set of IT resources or the second set of IT resources based on the ranking rule.

13. A resource managing information handling system, configured to:
receive a plurality of job requests from a plurality of user systems over a network;
determine a set of processing criteria for each job request;
determine a first return on investment (ROI) associated with a first set of a plurality of IT resources processing a first set of the plurality of job requests using and a second set of the plurality of IT resources processing a second set of the plurality of job requests;
determine a second ROI associated with processing the first set of the plurality of job requests using the second set of the plurality of IT resources and the second set of the plurality of job requests using the first set of the plurality of IT resources; and
send a set of instructions to the first set of IT resources and the second set of IT resources to process the first set of the plurality of job requests and the second set of the plurality of job requests based on the first ROI or the second ROI.

14. The resource managing information handling system of claim 13, wherein the set of processing criteria includes one or more of: a deadline for completion, a customer ranking, a minimum profitability threshold, and a maximum cost threshold.

15. The resource managing information handling system of claim 13, wherein the first set of IT resources comprises internal IT resources and the second set of IT resources comprises external IT resources communicatively coupled over a network.

16. The resource managing information handling system of claim 13, further configured to determine a third ROI associated with deprioritizing a third set of the plurality of job requests.

17. The resource managing information handling system of claim 13, wherein the set of processing criteria includes one or more of a revenue for fulfilling the job request and a cost for not fulfilling the job request.

18. The resource managing information handling system of claim 13, further configured to determine a ranking rule associated with one or more users and assign one or more of the first set of IT resources or the second set of IT resources based on the ranking rule.

19. The resource managing information handling system of claim 13, further configured to periodically communicate with a least one external information handling system to determine a cost associated with the external system.
